(19) United States
(12) Patent Application Publication
(10) Pub. No.: US 2008/0071962 A1
(43) Pub. Date: Mar. 20, 2008

(54) Device connection system and device connection method

(75) Inventors: Ming-Chien Yang, Taipei Shien (TW); Te-Hsien Lai, Banchiao City (TW); Yen-Ping Tung, Taipei Shien (TW); Chin-Tsai Yen, Taipei (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/730,840

(22) Filed: Apr. 4, 2007

(30) Foreign Application Priority Data
Sep. 18, 2006 (TW) 95134501

(51) Int. Cl. G06F 13/20; G06F 9/455

(52) U.S. Cl. 710/313; 703/24

(57) ABSTRACT

A device connection method for connecting a host having a peripheral bus to a peripheral device by the peripheral bus is provided. Firstly, as the peripheral device is connected to a peripheral gateway, a first information signal is outputted through a communication link. Next, a virtual device is mapped to the peripheral device in response to the first information signal, wherein the virtual device is compactable with the peripheral bus. Afterwards, as the peripheral bus of the host is connected to the virtual device, a second information signal is outputted through the peripheral bus in response to the first information signal to inform the host of a connection event taking place at the virtual device, so that the host enables the peripheral bus to install the peripheral device through the virtual device, wherein the host is connected to the peripheral device through the peripheral bus and the communication link.

This application claims the benefit of Taiwan application Serial No. 095134501, filed Sep. 18, 2006, the subject matter of which is incorporated herein by reference.

### BACKGROUND OF THE INVENTION

1. Field of the Invention

The invention relates in general to a device connection system, and more particularly to a device connection system for connecting an universal serial bus (USB) peripheral device by an USB over Internet protocol (IP) path.

2. Description of the Related Art

Conventional peripheral bus, such as universal serial bus (USB), has the advantages of stability, hot plug, and power-saving, but is subjected to the restriction of distance when in use. For example, the USB cable can not be longer than 5 meters. To resolve this problem, a USB server is provided. Conventional USB server is connected to a USB peripheral device via a USB and further converts the USB command transmitted between the USB server and the USB peripheral device to an Internet protocol (IP) package, so that the IP package is inputted to the host via a network hub. The host is a computer system. Despite the USB peripheral device can communicate with the host, conventional USB server still has several problems.

The computer system connected to conventional USB server has to install and run a driver of the USB server in order to be connected to the USB peripheral device via the USB server. However, the computer system can not be connected to the USB peripheral device if the conventional USB server is lack of a driver compatible with the operational system (OS) of the computer system. Furthermore, when the computer system is in a pre-OS environment, the computer system can not be connected to the USB peripheral device in the absence of an OS for running the driver of conventional USB server.

Besides, the computer system has to convert the received IP package to a USB command so as to know the USB command outputted from the USB peripheral device. However, the conversion between the IP package and the USB command takes a large amount of operating resources of the computer system.

### SUMMARY OF THE INVENTION

The invention is directed to a device connection system and a device connection method capable of resolving the problems encountered in a conventional device connection system that the conventional device connection system can not be connected in a pre-OS environment, not able to be connected due to the restriction of the operational system of computer system and occupies too much system resources.

According to a first aspect of the present invention, a device connection system for connecting a host having a first peripheral bus to a remote peripheral device by the first peripheral bus is provided. The device connection system comprises a peripheral gateway and a peripheral agent device. As the peripheral device is connected to a peripheral gateway, a first information signal is outputted by the peripheral gateway through a communication link. The peripheral agent device communicates with the peripheral gateway via the communication link. The peripheral agent device comprises a virtual device. The virtual device is compactable with the first peripheral bus. The peripheral agent device enables the virtual device to be mapped to the peripheral device in response to the first information signal. As the first bus of the host is connected to the virtual device of the peripheral agent device, the peripheral agent device in response to the first information signal, a second information signal is outputted by the peripheral agent device through the first bus to inform the host of a connection event taking place at the virtual device, so that the host enables the peripheral device to be installed by the first bus through the virtual device. Afterwards, the host is connected to the peripheral device by the first peripheral bus through the device connection system and the communication link.

According to a second aspect of the present invention, a device connection method for indirectly connecting a host having a first peripheral bus to a remote peripheral device by the first peripheral bus is provided. The device connection method comprises the following steps. Firstly, as the peripheral device is connected to a peripheral gateway, a first information signal is outputted through a communication link. Next, a virtual device is mapped to the peripheral device in response to the first information signal, wherein the virtual device is compactable with the first peripheral bus. Afterwards, as the first peripheral bus of the host is connected to the virtual device, a second information signal is outputted through the first peripheral bus in response to the first information signal to inform the host of a connection event taking place at the virtual device, so that the host enables the peripheral bus to install the peripheral device through the virtual device, wherein the host is connected to the peripheral device through the first peripheral bus and the communication link.

The invention will become apparent from the following detailed description of the preferred but non-limiting embodiments. The following description is made with reference to the accompanying drawings.

### BRIEF DESCRIPTION OF THE DRAWINGS

FIG. 1 is a system block diagram according to a device connection system of a preferred embodiment of the invention;

FIG. 2A is a detailed system block diagram of an exemplification of the peripheral gateway 110 of FIG. 1;

FIG. 2B a detailed system block diagram of an exemplification of the peripheral agent device 108 of FIG. 1; and

FIG. 3 is a flowchart of a device connection method according to a preferred embodiment of the invention.

### DETAILED DESCRIPTION OF THE INVENTION

The device connection system of the invention comprises a peripheral agent device and a peripheral gateway. The peripheral agent device is connected to a host by a bus. The peripheral gateway is connected to the peripheral device; wherein the peripheral agent device communicates with the peripheral gateway via a communication link. The device connection system of the invention further maps the peripheral device to a virtual device of the peripheral agent device, so that the host detects a local peripheral device and is connected thereto via a bus. Thus, the host is connected to a remote peripheral device via a bus and the device connection system.

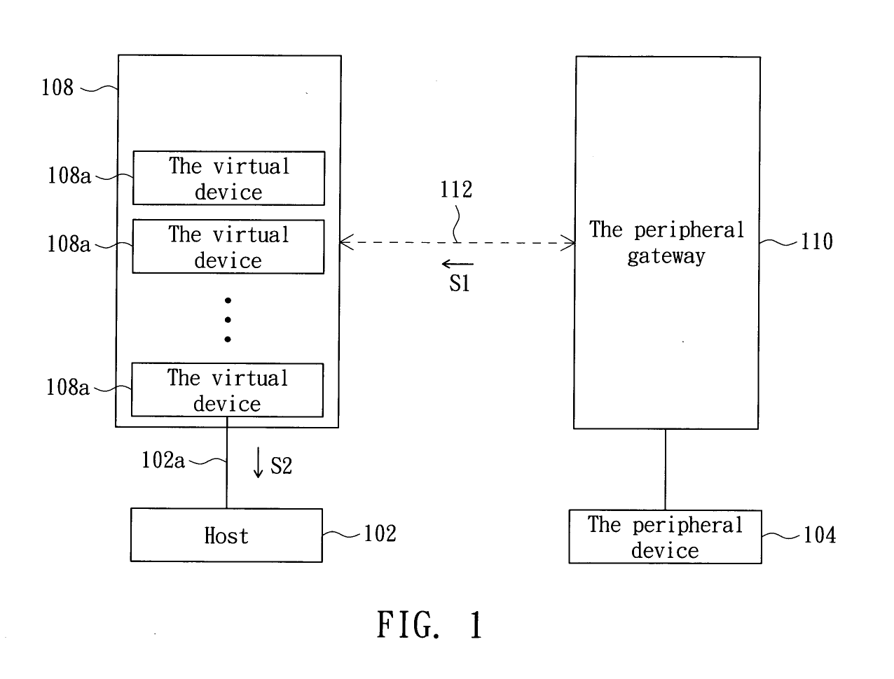

Referring to FIG. 1, a system block diagram according to a device connection system of a preferred embodiment of the invention is shown. The device connection system of the present embodiment of the invention connects a host 102 to a peripheral device 104 through a bus 102a and the device connection system. The device connection system comprises a peripheral agent device 108 and a peripheral gateway 110. The peripheral agent device 108 comprises a virtual device 108a compactable with the peripheral bus 102a. In the present embodiment of the invention, the peripheral agent device 108 comprises a number of virtual devices, and the number of virtual devices 108a is exemplified by seven.

The peripheral gateway 110 is connected to and communicates with the peripheral agent device 108 via a communication link 112. The peripheral gateway 110 outputs an information signal S1 through a communication link 112 as the peripheral device 104 is connected with the peripheral gateway 110. The peripheral agent device 108 receives the information signal S1, and maps the virtual device 108a to the peripheral device 104 in response to the information signal S1. The peripheral agent device 108 further outputs an information signal S2 in response to the information signal S1 as the host 102 is connected to the virtual device 108a of the peripheral agent device 108 by the bus 102a.

The information signal S2 informs the host 102 of a connection event taking place at the virtual device 108a through the bus 102a, so that the host 102 enables the peripheral device 104 to be installed by the bus 102a through the virtual device 108a. Afterward, the host 102 is connected to the peripheral device 104 through the bus 102a and the device connection system.

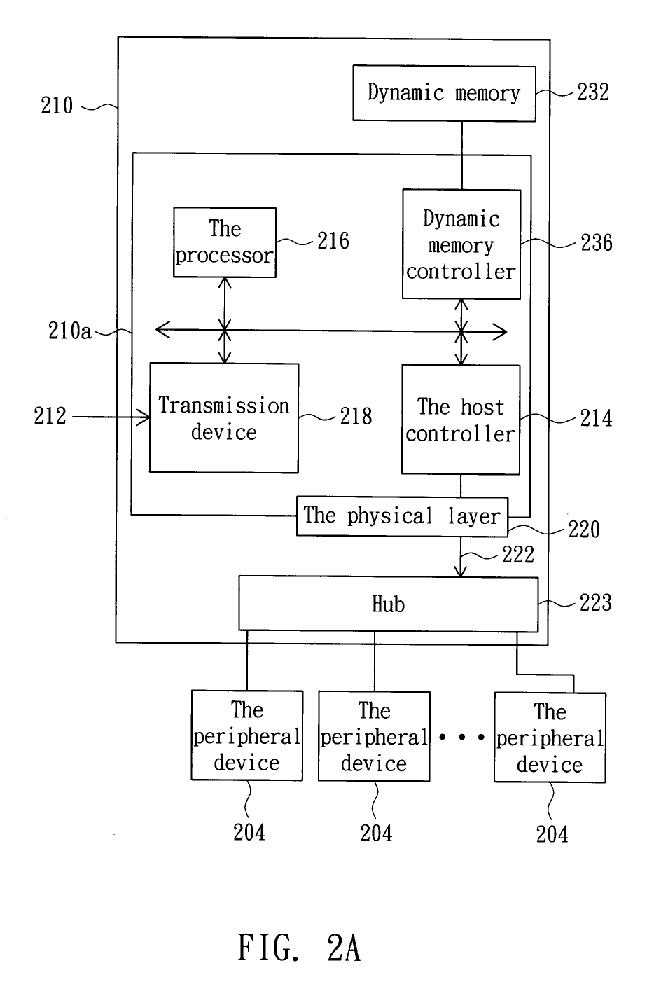

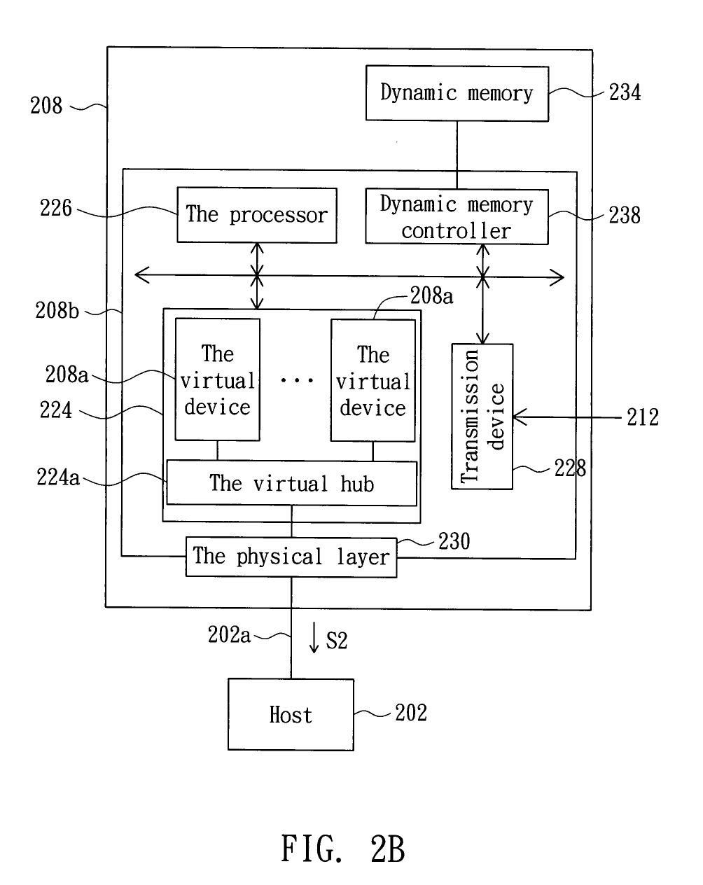

Referring to FIG. 2A, a detailed system block diagram of an exemplification of the peripheral gateway 110 of FIG. 1 is shown. Examples of the peripheral gateway 210 include a client embedded system which comprises a client SOC (SOC) 210a. The client SOC 210a comprises a host controller 214, a processor 216, a transmission device 218, a physical layer 220, a bus 222 and a hub 223. The host controller 214 is compactable with the bus 222, and is coupled to the hub 223 by the bus 222. The peripheral device 204 is also coupled to the hub 223 so as to be connected to the host controller 214 through the hub 223, the bus 222 and the physical layer 220.

The processor 216 is coupled to the host controller 214, and outputs an information signal S1 to indicate that the peripheral device 204 is connected to the client embedded system as the peripheral device 204 is connected to the host controller 214. The transmission device 218 is coupled to the processor 216 so as to be connected to the peripheral agent device 108 through a communication link 212.

Referring to FIG. 2B, a detailed system block diagram of an exemplification of the peripheral agent device 208 of FIG. 1 is shown. Examples of the peripheral agent device 108 include a host embedded system, which comprises a host SOC 208b. The host SOC 208b comprises a device controller 224, a processor 226, a transmission device 228 and a physical layer 230. The device controller 224 comprises a virtual device 208a and a virtual hub 224a. The device controller 224 is compactable with bus 202a, and is connected to the host 202 via the virtual hub 224a and the physical layer 230. The virtual device 208a is coupled to the virtual hub 224a so as to be coupled to the host 202 via the virtual hub 224a, the physical layer 230 and the bus 202a.

The processor 226 is coupled to the device controller 224. The processor 226 outputs an information signal S2 in response to information signal S1, as the bus 202a of the host 202 is connected to the device controller 224 via the physical layer 230 to inform the host 202 of a connection event taking place at the virtual device 208a through the bus 202a, so that the host 202 enables the peripheral device 204 to be installed. Thus, the virtual device 208a is used to simulate the peripheral device 204 being at the host embedded system, so that the host 202 detects a peripheral device via the bus 202a and is connected thereto. The transmission device 228 is coupled to the processor 226 so as to be connected to the peripheral gateway 210 through a communication link 212.

The processor 226 runs an embedded system operational system. The main functions of the host embedded system, such as informing the host 202 of the connection event taking place at the virtual device 208a or simulating the peripheral device 204 being at the host embedded system by the virtual device 208a, can be implemented by performing programs and hardware driver by the processor 226. The processor 216 also performs the embedded system operational system, and the main functions of the client embedded system, such as outputting an information signal S1, can also be implemented by performing programs and hardware driver by the processor 216.

Next, cite an example that both the buses 202a and 222 are a universal serial bus (USB), the host controller 214 is a USB host controller, the device controller 224 is a USB device controller, and the communication link 212 is a TCP/IP network such as the Internet for further explanation. The communication link 212 is a wireless network, a cabled network or a hybrid network.

The processor 216 of the client embedded system is used to perform a USB host controller driver, a USB core driver, a USB over Internet protocol (IP) peripheral driver and a client controller program. The processor 226 of the host embedded system performs the USB device controller driver, the USB over IP host driver and the host controller program.

As the peripheral device 204 is connected to the client embedded system, the USB host controller driver emulates the peripheral device 204, and registers the peripheral device 204 to the USB core driver. Then, the USB core driver calls the USB over IP device driver so as to complete the connection between the peripheral device 204 and the USB host controller. The USB over IP device driver enables a client controller program to output the information signal S1 to the host controller program via a network after the emulation of the peripheral device 204 is completed. The client controller program and the host controller program can be implemented by an application program which transmits the package in the form of an IP package.

The host controller program receives the information signal S1, and communicates with the USB over IP host driver and the USB device controller driver in response to the information signal S1 to obtain the number of peripheral devices 204 which have been simulated by the USB device controller. If the number of peripheral devices 204 simulated by the USB device controller is smaller than a predetermined number, such as seven for instance, this indicates that the USB device controller still has idled virtual devices 208a for simulating the peripheral device 204 to the host embedded system. Meanwhile, the host controller program starts to map the peripheral device 204 to the virtual device 208a, set the corresponding transmission endpoints and arrange the size of a first-in-first-out (FIFO) queue buffer so as to simulate the peripheral device 204 to the host embedded system.

After the USB device controller driver has finished the endpoint setting and the FIFO queue buffer size arrangement, the host controller program informs the client controller program. Then, the client controller program drives the USB over IP device driver to establish a connection plug at the kernel space, and after that, the USB over IP device driver and the USB over IP host driver transmit the IP package through the connection plug at the kernel space.

After the connection plug is established at the kernel space, the USB device controller drives the virtual device 208a to generate an information signal S2. The information signal S2 is transmitted to the host 202 via the USB to inform the host 202 of a connection event taking place at the virtual device 208a, so that the host 202 detects that a peripheral device is connected to the host 202 via the USB. Meanwhile, the host 202 is the master (the control node) of the USB which outputs request signals to the host embedded system. The request signals are converted to an IP package and outputted via an USB over IP host driver and a plug at the kernel space.

The USB over IP device driver receives and converts the IP packages to request signals. Then, the USB over IP device driver saves the request signals to the USB host controller via the USB core driver and the USB host controller driver. Next, the request signals are transmitted to the peripheral device 204. The response signal of the peripheral device 204 are transmitted to the host 202 via the above path but in opposite direction. Thus, the host 202 is connected to the peripheral device 204 via the device connection system.

The virtual device 208a further outputs a no acknowledgement package to the host 202 via the USB every USB spec waiting time interval to prevent the occurrence of bus time out error at the USB between the USB device controller and the host 202. Examples of the transmission devices 218 and 228 include giga-media access control (GMAC) device.

The client embedded system and the host embedded system respectively comprises a dynamic memory 232 and a dynamic memory 234. The client SOC 210a and the host SOC 208b respectively comprises a dynamic memory controller 236 and a dynamic memory controller 238 respectively coupled to the dynamic memory 232 and the dynamic memory 234 for controlling the access of the dynamic memory 232 and the dynamic memory 234 respectively.

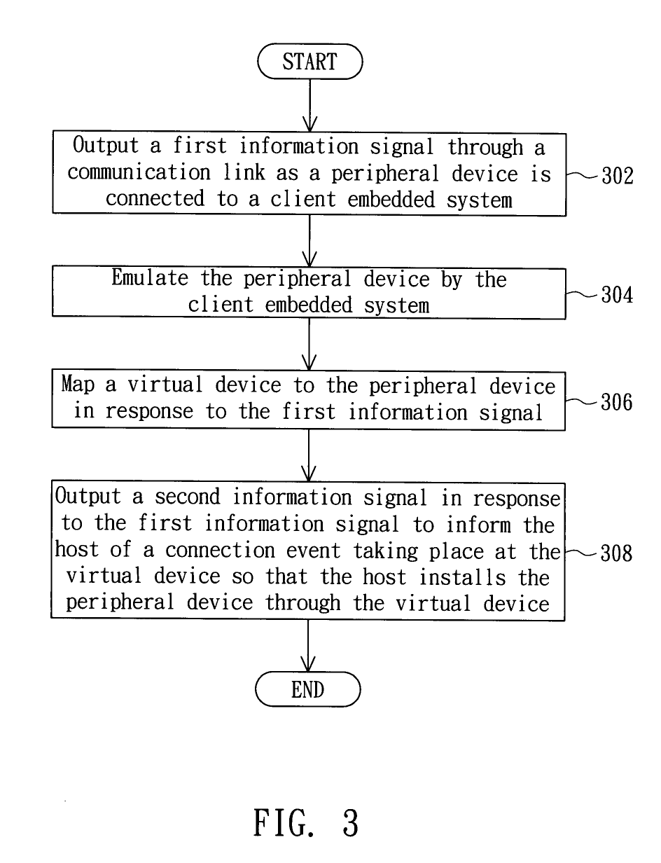

Referring to FIG. 3, a flowchart of a device connection method according to a preferred embodiment of the invention is shown. The device connection method of the present embodiment of the invention comprises the following steps. Firstly, the method begins at step 302, as the peripheral device 204 is connected to the client embedded system, an information signal S1 is outputted through a communication link 212. Next, the method proceeds to step 304, the client embedded system emulates the peripheral device 204. Then, the method proceeds to step 306, the virtual device 208a is mapped to the peripheral device 204 in response to the information signal S1.

Afterwards, the method proceeds to step 308, as the bus 202a of the host 202 is connected to the virtual device 208a, an information signal S2 is outputted through the bus 202a in response to the information signal S1 to inform the host 202 of the connection event taking place at the virtual device 208a, so that the host 202 enables the bus 202a to install the peripheral device 204 through the virtual device 208a. Thus, the host 202 is connected to the peripheral device 204 by the bus 202a through the device connection system.

In the present embodiment of the invention, the virtual hub 224a is a USB virtual hub. In the USB device controller of the present embodiment of the invention, all virtual devices 208a are coupled to the seven downstream ports of the USB virtual hub first, and the virtual devices 208a are connected to the physical layer 230 via the only upstream port of the USB virtual hub next. Thus, by disposing one physical layer 230 in the host SOC 208b, the host 202 can be connected to at most seven virtual devices 208a, hence saving both chip volume and chip cost for the host SOC 208b. The USB virtual hub is called USB virtual hub due to the absence of a physical layer.

According to the present embodiment of the invention, the USB virtual hub is incorporated with the host SOC 208b having only one physical layer 230, so that both the volume and the cost of the host SOC 208b are reduced. However, the host embedded system of the present embodiment of the invention is not limited to the above structure, and other structure types may do as well. For example, seven physical layers may be used for connecting the seven virtual devices 208a to the host 202 instead of using the USB virtual hub.

Despite the present embodiment of the invention is exemplified by the USB device controller having seven virtual devices 208a, the number of virtual devices 208a disposed in the host embedded system of the present embodiment of the invention is not limited to seven. For example, one virtual device may do as well. Thus, the host embedded system and the client embedded system respectively dispense with the use of the virtual hub 224a and the hub 223, so that the virtual device 208a and the peripheral device 204 are connected to the host 202 and the USB host controller 214 via the physical layer 230 and the physical layer 220 directly, respectively.

According to the present embodiment of the invention, the peripheral agent device 208 and the peripheral gateway 210 are respectively exemplified by a host client embedded system and a client embedded system, wherein the host embedded system and the client embedded system respectively comprise a host SOC 208b and a client SOC 210a. However, in the present embodiment of the invention, the peripheral agent device 208 and the peripheral gateway 210 are not limited to the structure of embedded system, and other system structures may do as well. Further, the host embedded system and the client embedded system are not limited to the system on chip structure, and other circuit structures may do as well.

In the host embedded system and client embedded system of the present embodiment of the invention, request signals are transmitted in the form of USB request block (URB). Despite both the buses 222 and 202a are exemplified by a USB in the present embodiment of the invention, however the bus 222 may be implemented by other forms such as RS-232, 1394 and so on. The bus 222 and the bus 202a do not have to be the same bus.

In the present embodiment of the invention, the host 202 is a computer host. The computer host is preferably a PC blade. The peripheral device 204 is a remote peripheral device of the PC blade, and examples of the remote peripheral device include monitor, speaker, keyboard and mouse. The peripheral agent device 208 simulates the remote peripheral device as a local device connected to a PC blade via a USB, and transmits electrical signals between the PC blade and the user interface. The peripheral gateway 210 receives the electrical signals outputted from the peripheral agent device 208 and then inputs the electrical signals to corresponding remote peripheral device 204.

Thus, the peripheral devices of multiple computer systems are integrated at the user end by a peripheral gateway, and the hardware core of multiple computer system such as central processor, dynamic memory and motherboard are centralized by multiple PC blades and corresponding peripheral agent devices and the peripheral agent devices are connected to the corresponding peripheral agent devices via a network. Therefore, the multiple computer systems are centralized, and the personnel, management time and cost related to computer management are reduced. The peripheral agent device may be disposed in a PC blade in the form of a system on chip structure to save the hardware space for the peripheral agent device.

According to the device connection system of the present embodiment of the invention, the host embedded system and the client embedded system are respectively connected to the host and the peripheral device via the USB, and the host embedded system is equipped with a processor for implementing the operation of the device connection system. Thus, the device connection system of the present embodiment of the invention enables the host to be connected to the peripheral device without using the USB server of conventional device connection system. Therefore, the device connection system of the present embodiment of the invention effectively resolves the problems occurring to conventional device connection system due to the absence of a compatible operational system (OS) version between the USB server and the operational system of the host. The device connection system of the present embodiment of the invention has the advantage of being compactable with the host having any version of operational system.

Besides, in the present embodiment of the invention, the host embedded system and the client embedded system are powered by a stand-by power source. Nonetheless, even the computer system is in a pre-OS environment, the host still can be connected to the peripheral device via the device connection system of the present embodiment of the invention. Such arrangement resolve the problems encountered in conventional device connection system that the driver of the USB server can be implemented only when the host is in an OS environment, and that the computer system can not be connected to the peripheral device in pre-OS environment. Therefore, the device connection system of the present embodiment of the invention has the advantage of being operational in a pre-OS environment.

Moreover, in the present embodiment of the invention, the host embedded system and the client embedded system both having a processor respectively receive and convert the USB command outputted from the host and the peripheral device to an IP package. The host embedded system and the client embedded system further respectively receive and convert the IP package outputted from the client embedded system and the host embedded system to a USB command, and input the USB command to the host and the peripheral device. Thus, the connection system of the present embodiment of the invention effectively resolves the problems encountered in conventional connection system that the host has to implement the conversion between USB command and IP package which consuming a large amount of resources of the host. Therefore, the device connection system of the present embodiment of the invention has the advantage of reducing operational load for the host.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A device connection system for connecting a host having a first peripheral bus to a remote peripheral device by the first peripheral bus, the device connection system comprising:
a peripheral gateway for outputting a first information signal through a communication link as a peripheral device is connected to the peripheral gateway; and
a peripheral agent device for communicating with the peripheral gateway through the communication link, wherein the peripheral agent device comprises:
a virtual device compactable with the first peripheral bus, wherein the peripheral agent device maps the virtual device to the peripheral device in response to the first information signal;
wherein, as the first bus of the host is connected to the virtual device of the peripheral agent device, the peripheral agent device outputs a second information signal in response to the first information signal through the first bus to inform the host of a connection event taking place at the virtual device, the host enables the first bus to install the peripheral device through the virtual device;
wherein after the host enables the first bus to install the peripheral device through the virtual device, the host is connected to the peripheral device through the first peripheral bus, the device connection system and the communication link.

2. The device connection system according to claim 1, wherein the peripheral gateway is a client embedded system.

3. The device connection system according to claim 2, wherein the client embedded system comprises:
a second peripheral bus; and
a host controller compactable with the second peripheral bus;
wherein the peripheral device is connected to the host controller by the second peripheral bus.

4. The device connection system according to claim 3, wherein the client embedded system further comprises:
a first processor coupled to the host controller, wherein as a peripheral device is connected to the host controller, the first processor outputs the first information signal to indicate that a peripheral device is connected to the client embedded system.

5. The device connection system according to claim 4, wherein the client embedded system further comprises:
a first transmission device coupled to the first processor and connected to the peripheral agent device through the communication link.

6. The device connection system according to claim 5, wherein the client embedded system further comprises:
a client system on chip (SOC) in which the host controller, the first processor, and the first transmission device are disposed.

7. The device connection system according to claim 1, wherein the peripheral agent device is a host embedded system.

8. The device connection system according to claim 7, wherein the host embedded system further comprises:
a device controller compactable with the first peripheral bus, wherein the virtual device is disposed in the device controller, and the host is coupled to the virtual device via the first peripheral bus and the device controller.

9. The device connection system according to claim 8, wherein the device controller further comprises:
a virtual hub coupled to the virtual device, wherein the host is coupled to the virtual device via the first peripheral bus, the device controller and the virtual hub.

10. The device connection system according to claim 9, wherein the host embedded system further comprises:
a second processor coupled to the virtual device, wherein as the first bus of the host is connected to the virtual device, the second processor outputs the second information signal through the first bus in response to the first information signal to inform the host of the connection event taking place at the virtual device, so that the host enables the first bus to install the peripheral device through the virtual device.

11. The device connection system according to claim 10, wherein the host embedded system further comprises:
a second transmission device coupled to the second processor and connected to the peripheral gateway through the communication link.

12. The device connection system according to claim 11, wherein the host embedded system further comprises:
a host SOC in which the device controller, the second processor and the second transmission device are disposed.

13. The device connection system according to claim 1, wherein both the first peripheral bus and the second peripheral bus are a universal serial bus (USB).

14. A device connection method for indirectly connecting a host having a first peripheral bus to a remote peripheral device by the first peripheral bus, the device connection method comprising:
outputting a first information signal through a communication link as a peripheral device is connected to a peripheral gateway;
mapping a virtual device to the peripheral device in response to the first information signal, wherein the virtual device is compactable with the first peripheral bus; and
outputting a second information signal through the first bus in response to the first information signal to inform the host of a connection event taking place at the virtual device as the first bus of the host is connected to the virtual device, so that the host enables the first bus to install the peripheral device through the virtual device;
wherein after the host enables the first bus to install the peripheral device through the virtual device, the host is connected to the peripheral device through the first peripheral bus and the communication link.

15. The device connection method according to claim 14, wherein further comprises:
emulating the peripheral gateway and the peripheral device.
